(19) United States
(12) Patent Application Publication
(10) Pub. No.: US 2023/0274765 A1
(43) Pub. Date: Aug. 31, 2023

(54) DATA RECORDING DEVICE AND DATA RECORDING METHOD

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Hiroaki SUGITA, Fuchu Tokyo (JP)

(21) Appl. No.: 17/901,274

(22) Filed: Sep. 1, 2022

(30) Foreign Application Priority Data
Feb. 28, 2022 (JP) 2022-029171

(51) Int. Cl. G11B 7/004; G11B 20/12; G06F 3/06

(52) U.S. Cl. CPC G11B 7/004; G11B 20/1217; G06F 3/061; G06F 3/0676; G06F 3/0628; G11B 2220/218

(57) ABSTRACT

A data recording device includes a recording medium, a control circuit configured to execute a read operation to read data from the recording medium or a write operation to write data on the recording medium, in response to a read or write request from an external device, and in accordance with one of a plurality of recording methods, a cache, a storage circuit configured to store a cache priority table in which a priority for storing read data or write data in the cache is set for each of the recording methods, and a cache control circuit configured to store the read data or the write data in the cache according to a priority set in the cache priority table for the read data and the recording method for the read data or for the write data and the recording method for the write data.

### CROSS-REFERENCE TO RELATED APPLICATION

This application is based upon and claims the benefit of priority from Japanese Patent Application No. 2022-029171, filed Feb. 28, 2022, the entire contents of which are incorporated herein by reference.

### FIELD

Embodiments described herein relate generally to a data recording device and a data recording method.

### BACKGROUND

In the related art, for a magnetic disk device, there is a technology that uses two recording methods on a single magnetic disk in combination. For example, a conventional magnetic recording (CMR) method that writes data with intervals in a radial direction for each track and a shingled magnetic recording (SMR) method that writes data in overlapping adjacent tracks in the radial direction.

In order to respond to a read request from a host system at high speed, there is a technology in which data for which there is a read request or a write request (or including data with a close logical block address (LBA)) is temporarily stored in a cache or the like. In such a case, when there is the read request from the host system, the data is transmitted to the host system from the cache when the requested data is in the cache or read from the magnetic disk when not in the cache. If the cache is full, the least recently used (LRU) method may be used to discard the data having the least recent access and replace the older data with new data.

### BRIEF DESCRIPTION OF THE DRAWINGS

FIG. 1 is a block diagram showing a configuration of a magnetic disk device according to an embodiment.

FIG. 2 is a descriptive diagram of CMR.

FIG. 3 is a descriptive diagram of SMR.

FIG. 4 is a table showing an example of a cache priority table according to an embodiment.

FIG. 5 is a diagram showing a transition example of data stored in a cache in an embodiment.

FIG. 6 is a flowchart of processing of a magnetic disk device at the time of receiving a read command in an embodiment.

FIG. 7 is a flowchart of processing of a magnetic disk device at the time of receiving a write command in an embodiment.

### DETAILED DESCRIPTION

When CMR and SMR methods are compared to one another, SMR takes longer when data is being overwritten on a magnetic disk because of the convenience of overwriting in a unit of so-called zone including a plurality of tracks. Accordingly, in general, for such a magnetic disk, hot data (high access frequency data) may be recorded in a CMR area, and cold data (low access frequency data) may be recorded in an SMR area.

However, in the related art, the data in the CMR area and the data in the SMR area are stored in the cache without distinction, so there is room for improvement in terms of input/output per second (IOPS) (which corresponds to the number of times that a read or a write is able to be executed per second).

Embodiments of the present disclosure provide improved IOPS in a data recording device in which a plurality of recording methods are used in combination.

In general, according to one embodiment, a data recording device includes a recording medium on which data is recorded, a control circuit configured to execute a read operation to read data from the recording medium and a write operation to write data on the recording medium, in response to a read request and a write request from an external device, respectively, and in accordance with one of a plurality of recording methods, a cache, a storage circuit configured to store a cache priority table in which a priority for storing read data or write data in the cache is set for each of the recording methods, and a cache control circuit configured to store the read data in the cache according to a priority set in the cache priority table for the read data and the recording method for the read data and to store the write data in the cache according to a priority set in the cache priority table for the write data and the recording method for the write data.

Hereinafter, an example embodiment of a data recording device and a data recording method will be described with reference to the drawings. The drawings and the following description are examples, and do not limit the scope of the present disclosure. In the following, a magnetic disk device will be described as one example of a data recording device.

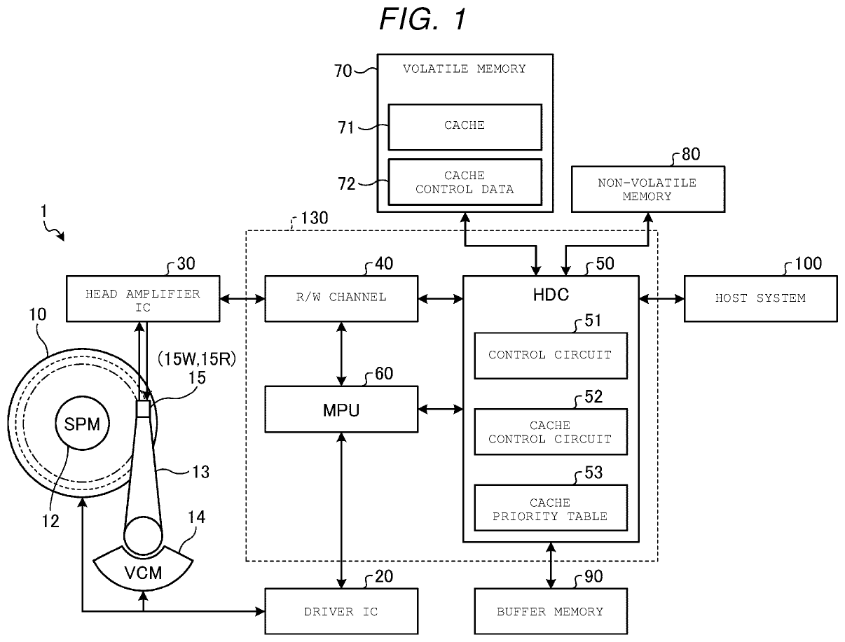

FIG. 1 is a block diagram showing a configuration of a magnetic disk device 1 according to an embodiment. The magnetic disk device 1 includes a head disk assembly (HDA), a driver IC 20, a head amplifier IC 30, a volatile memory 70, a non-volatile memory 80, a buffer memory 90, and a system controller 130 that is an integrated circuit of one chip. Further, the magnetic disk device 1 is coupled to a host system 100 (which is an external device).

The HDA includes a magnetic disk 10 (recording medium), a spindle motor (SPM) 12, a head 15, an arm 13 on which the head 15 is mounted, and a voice coil motor (VCM) 14. The magnetic disk 10 is attached to the SPM 12 and is rotated by the SPM 12. The arm 13 and the VCM 14 together constitute an actuator. The actuator can move the head 15 (mounted on the arm 13) to a position above the magnetic disk 10 by the controlling (driving) the VCM 14. In some examples, more than one magnetic disk 10 and head 15 may be provided in the magnetic disk device 1.

The magnetic disk 10 has an area that records data. With respect to the magnetic disk 10, two recording methods (as an example of a plurality of recording methods) are used in combination. A conventional magnetic recording (CMR) method that writes data into tracks spaced at intervals in a radial direction from each other and a shingled magnetic recording (SMR) method that writes data into tracks that partially overlap one another in the radial direction are used.

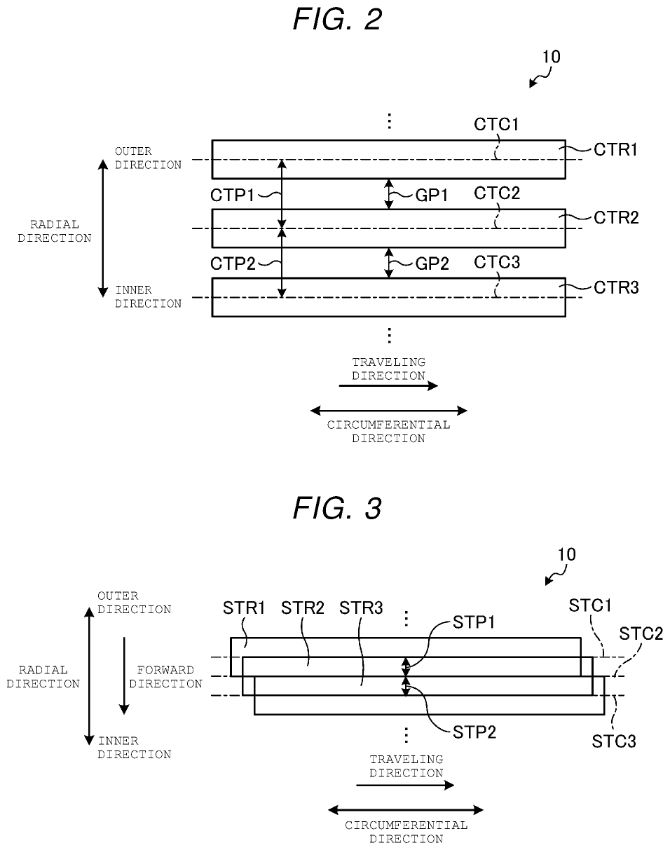

These different recording methods (CMR and SMR) will be described with reference to FIGS. 2 and 3. FIG. 2 is a descriptive diagram of CMR. FIG. 2 shows a traveling direction. The traveling direction is a direction along which the head 15 sequentially writes or reads data corresponding to a circumferential direction on the magnetic disk 10 (The traveling direction is a direction opposite to the rotation direction of the magnetic disk 10).

FIG. 2 shows individual CMR tracks CTR1, CTR2, and CTR3. Also depicted is a track center CTC1 of the CMR track CTR1, a track center CTC2 of the CMR track CTR2, and a track center CTC3 of the CMR track CTR3. The CMR tracks CTR1 and CTR2 are written at a track pitch CTP1. The CMR tracks CTR2 and CTR3 are written at a track pitch CTP2. The track center CTC1 of the CMR track CTR1 and the track center CTC2 of the CMR track CTR2 are separated by the track pitch CTP1. The track center CTC2 of the CMR track CTR2 and the track center CTC3 of the CMR track CTR3 are separated by the track pitch CTP2.

The CMR track CTR1 and the CMR track CTR2 are separated by a gap GP1. The CMR track CTR2 and the CMR track CTR3 are separated by a gap GP2. Although each track is shown in a rectangular shape in FIG. 2 for representational convenience, each is actually curved along the circumferential direction.

FIG. 3 is a descriptive diagram of SMR. FIG. 3 shows a forward direction. The forward direction is the direction in which a plurality of tracks are continuously recorded in a shingled manner along the radial direction on the magnetic disk 10, that is, the direction in which the next track to be written is overlapped with respect to the previously written track.

FIG. 3 shows a plurality of individual SMR tracks STR1, STR2, and STR3 that are continuously overlapped with one another in a direction along the radial direction. Also depicted in FIG. 3 is a track center STC1 of the SMR track STR1, a track center STC2 of the SMR track STR2, and a track center STC3 of the SMR track STR3. These centers are based on the full (non-overlapped) track width of these SMR-type tracks as written.

In the example shown in FIG. 3, the SMR tracks STR1 and STR2 are written at a track pitch STP1 (recording pitch). The SMR tracks STR2 and STR3 are written at the track pitch STP2 (recording pitch). The track center STC1 of the SMR track STR1 and the track center STC2 of the SMR track STR2 are separated by the recording pitch STP1. The track center STC2 of the SMR track STR2 and the track center STC3 of the SMR track STR3 are separated by a recording pitch STP2.

Although each track is shown in a rectangular shape in FIG. 3 for representational convenience, each track is actually curved along the circumferential direction.

Returning to FIG. 1, the head 15 includes a write head 15W and a read head 15R mounted on a slider, which is a main body. The write head 15W writes data to the magnetic disk 10. The read head 15R reads the data previously written on the magnetic disk 10.

The driver IC 20 controls the drive of the SPM 12 and the VCM 14 according to the control from the system controller 130.

The head amplifier IC 30 includes a read amplifier, a write driver, and the like. The read amplifier amplifies a read signal as read from the magnetic disk 10 and outputs the amplified read signal to the system controller 130. The write driver outputs a write current in accordance with a signal output from an R/W channel 40 to the head 15.

The volatile memory 70 is a semiconductor-type memory in which stored data might be lost when power supply is cut off. The volatile memory 70 stores data and the like necessary for processing and operations of the magnetic disk device 1. The volatile memory 70 is, for example, a dynamic random access memory (DRAM), a synchronous dynamic random access memory (SDRAM), or the like.

The volatile memory 70 includes a cache 71 and cache control data 72. In order to respond to a read request from the host system 100 at high speed, the cache 71 temporarily stores data for which the read request or the write request is considered likely to be made from the host system 100 (or the data with a close logical block address (LBA) to such data). When the cache 71 is full, for example, the least recently used (LRU) method can be used to discard the data having the least recent access and replace this “old” data with new data. The cache control data 72 is data necessary for cache control operations.

The non-volatile memory 80 is a semiconductor-type memory in which stored data is not lost even when power supply is cut off. The non-volatile memory 80 is, for example, a NOR type or NAND type flash read only memory (FROM).

The buffer memory 90 is a semiconductor-type memory that temporarily records data and the like communicated between the magnetic disk device 1 and the host system 100. The buffer memory 90 may be integrally combined with the volatile memory 70 in some examples. The buffer memory 90 is, for example, DRAM, static random access memory (SRAM), SDRAM, ferroelectric random access memory (FeRAM), magnetoresistive random access memory (MRAM), or the like.

The system controller 130 is implemented by using, for example, a large-scale integrated circuit (LSI) called a system-on-a-chip (SoC) in which a plurality of circuit elements are integrated on a single chip. The circuit elements of the system controller 130 include a R/W (read/write) channel 40, a hard disk controller (HDC) 50, and a microprocessor (MPU) 60. The system controller 130 is electrically coupled to the driver IC 20, the head amplifier IC 30, the volatile memory 70, the non-volatile memory 80, the buffer memory 90, the host system 100, and the like.

The R/W channel 40 executes signal processing of data (i.e., read data) being transferred from the magnetic disk 10 to the host system 100 and data (i.e., write data) transferred from the host system 100 according to an instruction from the MPU 60. The R/W channel 40 has a circuit or a function of modulating the write data. The R/W channel 40 has a circuit or function for measuring and demodulating the signal quality of the read data. The R/W channel 40 is electrically coupled to, for example, the head amplifier IC 30, the HDC 50, the MPU 60, and the like.

The HDC 50 controls data transfers and the like. For example, the HDC 50 controls the transfer of data between the host system 100 and the magnetic disk 10 according to an instruction from the MPU 60. The HDC 50 is electrically coupled to, for example, the R/W channel 40, the MPU 60, the volatile memory 70, the non-volatile memory 80, the buffer memory 90, the host system 100, and the like.

The HDC 50 includes a control circuit 51, a cache control circuit 52, and a cache priority table 53 implemented in a storage circuit, e.g., a register, DRAM, SRAM, or SDRAM.

The control circuit 51 executes various controls related to the reading of data and the writing of data from and to the magnetic disk 10. For example, when a read request or a write request is made from the host system 100 designating either CMR or SMR, the control circuit 51 controls the MPU 60 and the like to execute read or write in accordance with the designated recording method.

When there is a read request or a write request from the host system 100, the cache control circuit 52 refers to the cache priority table 53 and stores data in the cache 71 according to the corresponding priority.

The cache priority table 53 is an information table in which the priority for storage in the cache 71 for each read or write is able to be set for each recording method.

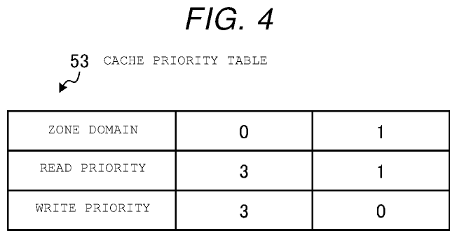

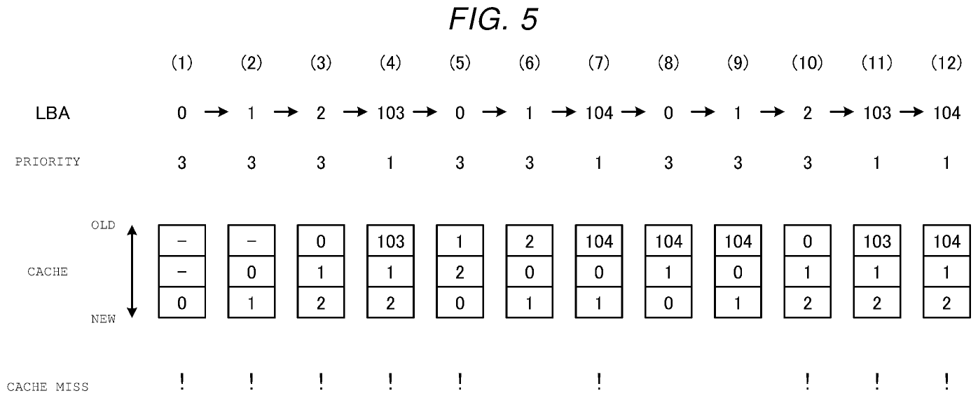

FIG. 4 is a table showing an example of the cache priority table 53 according to the embodiment. FIG. 5 is a diagram showing a transition example of data stored in the cache 71 in an embodiment. As shown in FIG. 4, in the cache priority table 53, the read priority and the write priority are able to be separately set for each zone domain.

The zone domain is information indicating a type of zone. In the present example, “0” indicates the zone type for CMR and “1” indicates the zone type for SMR. A zone for CMR and a zone for SMR are established for the magnetic disk 10, and a separate LBA is assigned to each zone. Each portion of the magnetic disk 10 is one of the zone for CMR or the zone for SMR.

The read priority and write priority (hereinafter, also referred to as “priority” or “cache priority”) indicate that data is treated as old data (low priority data) in the decreasing order of “3”→“2”→“1.” In this example, it is assumed that the cache 71 uses the LRU method and has three storage areas (stages). That is, the three storage areas of the cache 71 in FIG. 5 are the data of priority “3”→“2”→“1” enters in order from the bottom (“NEW”). The designated priority “0” indicates that the data is not placed in the storage area of the cache 71.

In FIG. 4, the priority of the data of CMR-type is set to “3”, which is the highest for both read and write. On the other hand, the priority of read of the data of SMR-type is set to “1,” which assumes little demand for the data at a later time. The priority of write of the data of SMR-type is set to “0” on the assumption that there is very little subsequent demand.

In the example of FIG. 5, only the read requests are shown. Furthermore in FIG. 5, values of “0”, “1”, and “2” for the LBA row indicate a read request data of CMR-type, and values of “103” and “104” indicate a read request data of SMR-type.

The transition of the stored data in the cache 71 at different points in time labeled (1) to (12) will be described. In FIG. 5, when the requested data is not able to be read from the cache 71, it is represented as a cache miss with a value of “!” in the “CACHE MISS” row. If there is a cache miss, the corresponding requested data is read from the magnetic disk 10 instead of the cache 71.

At time (1), a read request data “0” of CMR-type of priority “3” enters the latest storage area. Since the read request data “0” (LBA “0”) was not already stored in the cache 71, a cache miss occurs.

At time (2), the read request data “1” of CMR-type of the priority “3” enters the latest storage area. Since the read request data “1” is not already stored in the cache 71, a cache miss occurs.

At time (3), the read request data “2” of CMR-type of the priority “3” enters the latest storage area. Since the read request data “2” is not already stored in the cache 71, a cache miss occurs.

At time (4), the read request data “103” of SMR-type of the priority “1” is placed in the oldest storage area, and the read request data “0” that was previously in the oldest storage area at time (3) is now discarded. Since the read request data “103” was not already stored in the cache 71, a cache miss occurs.

At time (5), the read request data “0” of CMR-type of the priority “3” is placed in the latest storage area, and the read request data “103” previously in the oldest storage area is now discarded. Since the read request data “0” was not already stored in the cache 71, a cache miss occurs.

At time (6), the read request data “1” of CMR-type of the priority “3” is successfully read from the cache 71 and moved to the latest (NEW) storage area.

At time (7), the read request data “104” of SMR-type of the priority “1” is placed in the oldest storage area, and the read request data “2” previously in the oldest storage area is discarded. Since the read request data “104” was not already stored in the cache 71, a cache miss occurs.

At time (8), the read request data “0” of CMR-type of the priority “3” is successfully read from the cache 71 and moved to the latest storage area.

At time (9), the read request data “1” of CMR-type of the priority “3” is successfully read from the cache 71 and moved to the latest storage area.

At time (10), the read request data “2” of CMR-type of the priority “3” is placed in the latest storage area, and the read request data “104” previously in the oldest storage area is discarded. Since the read request data “2” was not already stored in the cache 71, a cache miss occurs.

At time (11), the read request data “103” of SMR-type of the priority “1” is placed in the oldest storage area, and the read request data “0” previously in the oldest storage area is discarded. Since the read request data “103” was not already stored in the cache 71, a cache miss occurs.

At time (12), the read request data “104” of SMR-type of the priority “1” is placed in the oldest storage area, and the read request data “103” previously in the oldest storage area up is discarded. Since the read request data “104” was not already stored in the cache 71, a cache miss occurs.

As described above, since the read request data of CMR-type, which is hot data, is likely to be used soon next, the staying time in the cache 71 is lengthened by placing the read request data in the latest storage area of the cache 71. Further, since the read request data of SMR-type, which is cold data, is unlikely to be used soon next, the staying time in the cache 71 is shortened by placing the read request data in the oldest storage area of the cache 71. As a result, IOPS is able to be improved as compared with the related art in which both data are stored in the cache without distinction.

Further, although the read request data is described with reference to FIG. 5, the same applies to the write request data. Compared with the read request data, in the write request data, the write request data of SMR-type is different in that the write request data is not stored in the cache 71 because the priority is set to “0”.

Returning to FIG. 1, when the cache control circuit 52 receives a change command of the priority from the host system 100, the cache control circuit 52 changes setting of the priority of the cache priority table 53 according to the change command.

The MPU 60 is a main controller that controls each portion of the magnetic disk device 1. The MPU 60 controls the VCM 14 via the driver IC 20 and executes servo control to position the head 15. The MPU 60 controls the SPM 12 via the driver IC 20 and rotates the magnetic disk 10. The MPU 60 controls the write operation to write data to the magnetic disk 10, and also selects a storage destination of the data transferred from the host system 100, for example, the write data. Further, the MPU 60 controls the read operation of to read data from the magnetic disk 10, and also controls the processing of the data transferred from the magnetic disk 10 to the host system 100, for example, the read data. Further, the MPU 60 manages an area for recording the data. The MPU 60 is coupled to each portion of the magnetic disk device 1. The MPU 60 is electrically coupled to, for example, the driver IC 20, the R/W channel 40, the HDC 50, and the like.

Further, the MPU 60 controls the read process of reading data from the magnetic disk 10 and the write process of writing data to the magnetic disk 10 according to a command and the like from the host system 100.

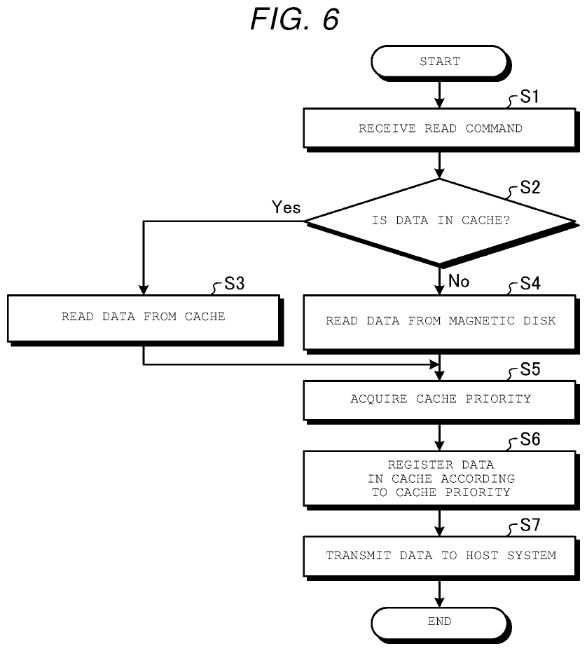

Next, FIG. 6 is a flowchart showing processing at the time of receiving a read command by the magnetic disk device 1 of the embodiment. In step S1, the HDC 50 receives a read command from the host system 100.

Next, in step S2, the control circuit 51 determines whether there is corresponding data in the cache 71, and if Yes, the process proceeds to step S3, and if No, the process proceeds to step S4.

In step S3, the control circuit 51 reads data from the cache 71.

In step S4, the control circuit 51 controls the MPU 60 and the like to read data from the magnetic disk 10.

In step S5, the cache control circuit 52 determines the zone domain of the data read from the magnetic disk 10 based on the LBA, and refers to the cache priority table 53 to acquire a corresponding cache priority (refer to FIG. 4).

Next, in step S6, the cache control circuit 52 registers the data in the cache 71 according to the cache priority acquired in step S5 (refer to FIG. 5).

Next, in step S7, the control circuit 51 transmits the data read from the cache 71 or the magnetic disk 10 to the host system 100.

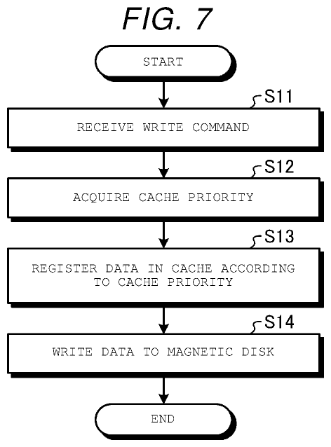

Next, FIG. 7 is a flowchart showing processing at the time of receiving a write command by the magnetic disk device 1 of the embodiment. In step S11, the HDC 50 receives a write command from the host system 100.

Next, in step S12, the cache control circuit 52 determines the zone domain of the data to be written to the magnetic disk 10 based on the LBA, and refers to the cache priority table 53 to acquire a corresponding cache priority (see FIG. 4).

Next, in step S13, the cache control circuit 52 registers data in the cache 71 according to the cache priority acquired in step S12 (see FIG. 5).

Next, in step S14, the control circuit 51 controls the MPU 60 and the like to write data to the magnetic disk 10.

As described above, according to the magnetic disk device 1 of the present embodiment, when a plurality of recording methods (CMR, SMR) are used in combination, the cache priority table 53 is referred to when a read request or a write request is received from the host system 100, and the data is stored in the cache 71 according to the corresponding priority. As a result, IOPS is able to be improved by reducing the number of cache misses in the cache 71 as compared with the related art.

Further, by using the change command of the priority, the priority of the cache priority table 53 is able to be changed flexibly according to actual usage patterns.

Further, a program executed by the magnetic disk device 1 of the present embodiment is a file in an installable format or an executable format, and is provided on a recording medium that is able to be read by a computer device, such as a compact disc (CD)-read only memory (ROM), a flexible disk (FD), a CD-recordable (R), and digital versatile disk (DVD). Further, the corresponding program may be provided or distributed via a network such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

For example, the data recording device of the present disclosure is not limited to the magnetic disk device, and may be another data recording device such as a NAND flash memory in which a plurality of recording methods are used in combination.

What is claimed is:

1. A data recording device comprising:
a recording medium on which data is recorded;
a control circuit configured to execute a read operation to read data from the recording medium and a write operation to write data on the recording medium, in response to a read request and a write request from an external device, respectively, and in accordance with one of a plurality of recording methods;
a cache;
a storage circuit configured to store a cache priority table in which a priority for storing read data or write data in the cache is set for each of the recording methods; and
a cache control circuit configured to store the read data in the cache according to a priority set in the cache priority table for the read data and the recording method for the read data and to store the write data in the cache according to a priority set in the cache priority table for the write data and the recording method for the write data.

2. The data recording device according to claim 1, wherein
the cache control circuit is configured to change priorities set in the cache priority table in response to a change command received from the external device.

3. The data recording device according to claim 1, wherein
the recording medium is a magnetic disk, and
the plurality of recording methods include a conventional magnetic recording (CMR) method and a shingled magnetic recording (SMR) method.

4. The data recording device according to claim 3, wherein a higher priority is set for both the read data and the write data when the recording method is the CMR method than when the recording method is the SMR method.

5. The data recording device according to claim 3, wherein a higher priority is set for the read data when the recording method is the SMR method than for the write data when the recording method is the SMR method.

6. The data recording device according to claim 3, wherein the same priority is set for the read data when the recording method is the CMR method as for the write data when the recording method is the CMR method.

7. The data recording device according to claim 1, wherein the read data is stored in the cache after the read data is read from the recording medium.

8. The data recording device according to claim 1, wherein the write data is stored in the cache before the write data is written on the recording medium.

9. The data recording device according to claim 1, wherein the recording method for the read data or the write data is determined from a logical block address designated in the read request or the write request.

10. A data recording method executed by a data recording device including a recording medium on which data is recorded, in response to a write request from an external device, the method comprising:
acquiring a priority for storing write data of the write request in a cache, from a cache priority table in which different priorities for storing data in the cache are stored;
storing the write data in the cache according to the priority acquired from the cache priority table; and
performing a write operation to write the write data on the recording medium.

11. The data recording method according to claim 10, wherein the priority is acquired from the cache priority table in accordance with a recording method for the write data.

12. The data recording method according to claim 11, further comprising:
determining the recording method from a logical block address designated in the write request.

13. The data recording method according to claim 10, wherein a first priority is set in the cache priority table for the write data to be stored according to a conventional magnetic recording method and a second priority is set in the cache priority table for the write data to be stored according to a shingled magnetic recording method.

14. The data recording method according to claim 13, wherein the first priority is higher than the second priority.

15. The data recording method according to claim 14, further comprising:
changing priorities set in the cache priority table in response to a change command received from the external device.

16. A data reading method executed by a data recording device including a recording medium on which data is recorded, in response to a read request from an external device, the method comprising:
performing a read operation to acquire read data from the recording medium;
acquiring a priority for storing the read data in a cache, from a cache priority table in which different priorities for storing data in the cache are stored; and
storing the read data in the cache according to the priority acquired from the cache priority table.

17. The data reading method according to claim 16, wherein the priority is acquired from the cache priority table in accordance with a recording method for the read data.

18. The data reading method according to claim 17, further comprising:
determining the recording method from a logical block address designated in the read request.

19. The data reading method according to claim 16, wherein a first priority is set in the cache priority table for the write data to be stored according to a conventional magnetic recording method and a second priority is set in the cache priority table for the write data to be stored according to a shingled magnetic recording method.

20. The data reading method according to claim 19, wherein the first priority is higher than the second priority.
